(19) United States
(12) Patent Application Publication
(10) Pub. No.: US 2020/0311309 A1
(43) Pub. Date: Oct. 1, 2020

(54) ENCRYPTION TECHNIQUES FOR COOKIE SECURITY

(71) Applicant: salesforce.com, inc., San Francisco, CA (US)

(72) Inventors: Puneet Kumar Dawer, Hyderabad (IN); Chandra Sekhar Varanasi, Hyderabad (IN); Neelamani Durga Siva Prasad Kolluru, Hyderabad (IN); Raju Rama Krishnam Chekuri, Hyderabad (IN); Amrendra Singh, Hyderabad (IN); Rakesh Garishakurthi, Hyderabad (IN)

(21) Appl. No.: 16/365,067

(22) Filed: Mar. 26, 2019

(51) Int. Cl. G06F 21/62; H04L 9/30; H04L 9/14; H04L 9/32; H04L 9/08; G06F 21/60

(52) U.S. Cl. CPC G06F 21/6263; H04L 9/3073; H04L 9/14; G06F 21/602; H04L 9/0819; H04L 9/0894; H04L 9/3297

(57) ABSTRACT

Techniques are disclosed relating to preventing unauthorized access to private user information by improving cookie security. Cookie data may be subject to interception and replay attempts by malicious users. In disclosed techniques, a server computing system receives a request from a user device that includes encrypted cookie data and device identification information encrypted using a first key of a key pair generated by the server system. The server system may decrypt encrypted cookie data included with the request using a server encryption key. Based on decrypting the cookie data, the server system may retrieve previously-stored device identification information. The server system may decrypt device identification information received with the request using a second key of the key pair. The server system may compare the decryption result with the previously-stored device identification information and, based on the comparison, determine whether to use the cookie data for the request.

### BACKGROUND

### Technical Field

This disclosure relates generally to cookie messages and, in particular, to improving cookie security using encryption techniques.

### Description of the Related Art

Cookie data is often used by a web server to store and quickly provide information from previous activity during a user session to a user. The web server may send cookie data to the user device during a first user visit to a website, for example. During a subsequent visit to the same website, the user device may return the cookie data to the web server. Cookie data, however, may be subject to interception by a malicious user and may be replayed using a man-in-the-middle attack, allowing the malicious user to inappropriately gain access to private user information.

### BRIEF DESCRIPTION OF THE DRAWINGS

FIG. 1 is a block diagram illustrating an example system configured to verify encrypted cookie data received from a user device, according to some embodiments.

FIG. 2 is a communication diagram illustrating an example initial request and cookie encryption using a server encryption key, according to some embodiments.

FIG. 3 is a communication diagram illustrating an example subsequent request that uses an encrypted cookie and a machine fingerprint, according to some embodiments.

FIG. 4 is a flow diagram illustrating an example method for determining whether to use encrypted cookie data for a request from a user device, according to some embodiments.

FIG. 5 is a block diagram illustrating an example computing device, according to some embodiments.

This disclosure includes references to “one embodiment,” “a particular embodiment,” “some embodiments,” “various embodiments,” “an embodiment,” etc. The appearances of these phrases do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. For example, a “server computing system configured to generate a key pair” is intended to cover, for example, equipment that has a program code or circuitry that performs this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the context clearly dictates otherwise. Furthermore, the words “can” and “may” are used throughout this application in a permissive sense (i.e., having the potential to, being able to), not in a mandatory sense (i.e., must). The term “include,” “comprise,” and derivations thereof, mean “including, but not limited to.” The term “coupled” means directly or indirectly connected.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

### DETAILED DESCRIPTION

In various disclosed embodiments, a server computing system is configured to prevent unauthorized access to private user information by implementing cookie security techniques. For example, the server computing system may encrypt cookie data using a server encryption key, store device identification information associated with a user device, generate a key pair for encrypting other information, and verify that both device identification information and cookie data were properly encrypted. Various techniques discussed herein may reduce or prevent interception and replay of cookie data during man-in-the-middle attacks. For example, the server computing system may be a web server that rejects cookie data, received from a web browser on a user device, in response to failure of one or more verification steps.

In disclosed embodiments, a verification step may fail if the server computing system does not receive cookie data and/or device identification information from a user device. Similarly, if received cookie data or device identification information received from the user device is not properly encrypted (or is not encrypted at all). In this scenario, the server computing system will determine not to use the cookie data for a user request. In this way, the server computing system may reduce or avoid situations where malicious users improperly access private user information.

### Overview of Encrypted Cookie Use

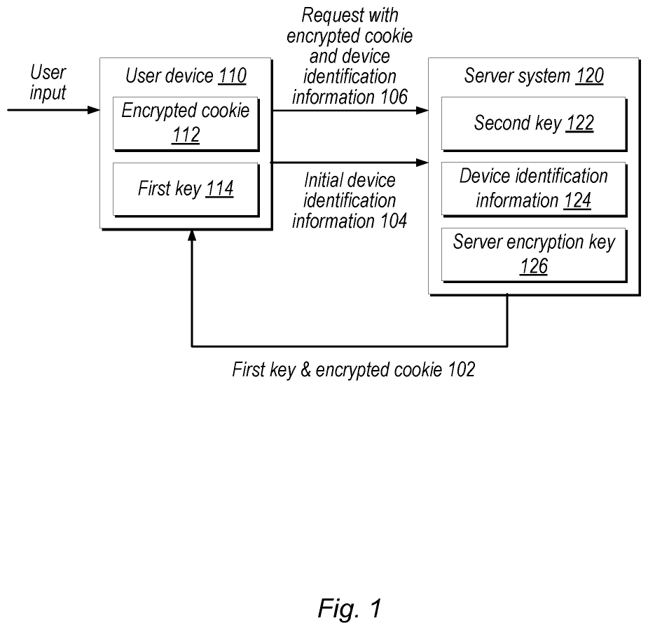

FIG. 1 is a block diagram illustrating an example system configured to verify encrypted cookie data, according to some embodiments. In the illustrated embodiment, server system 120 communicates with user device 110 during one or more user sessions. Speaking generally, the illustrated example shows a system state where the user device 110 and server system 120 have already exchanged encryption key information, an encrypted cookie, and device identification information.

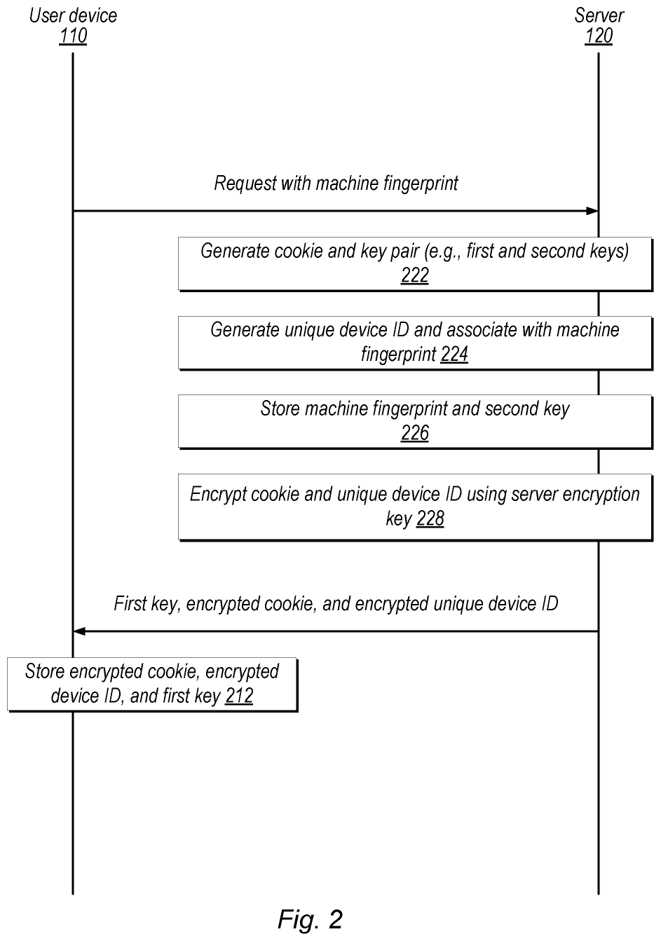

In the illustrated example, during an initial exchange for a cookie, server system 120 sends a message 102 with first key 114 and encrypted cookie 112 to user device 110, which stores this information as shown. In conjunction with message 102, user device 110 sends message 104 with initial device identification information to server system 120, which stores the information as device identification information 124. Example techniques for this initial exchange are discussed in further detail below with reference to FIG. 2.

Therefore, in the illustrated example, user device 110 stores encrypted cookie 112 and first key 114 received from server system 120, e.g., for use in subsequent requests. Server system 120 stores device identification information 124 received from user device 110 and also stores second key 122 (which may be paired with first key 114) and server encryption key 126 (which may have been used to encrypt encrypted cookie 112).

User device 110, in the illustrated embodiment, receives user input. In some embodiments, the user input includes user identification information (e.g., account credentials such as a username and password) for a website that the user is attempting to access. For example, the user may be attempting to access an account via a web browser. In some embodiments, the user input includes a user navigating to a particular web page using a web browser.

In the illustrated embodiment, in response to receiving input from a user, user device 110 sends a message 106, which is a request with encrypted cookie data 112 and encrypted device identification information, to server system 120. In some embodiments, user device 110 generates current device identification information and encrypts it using first key 114 to generate message 106

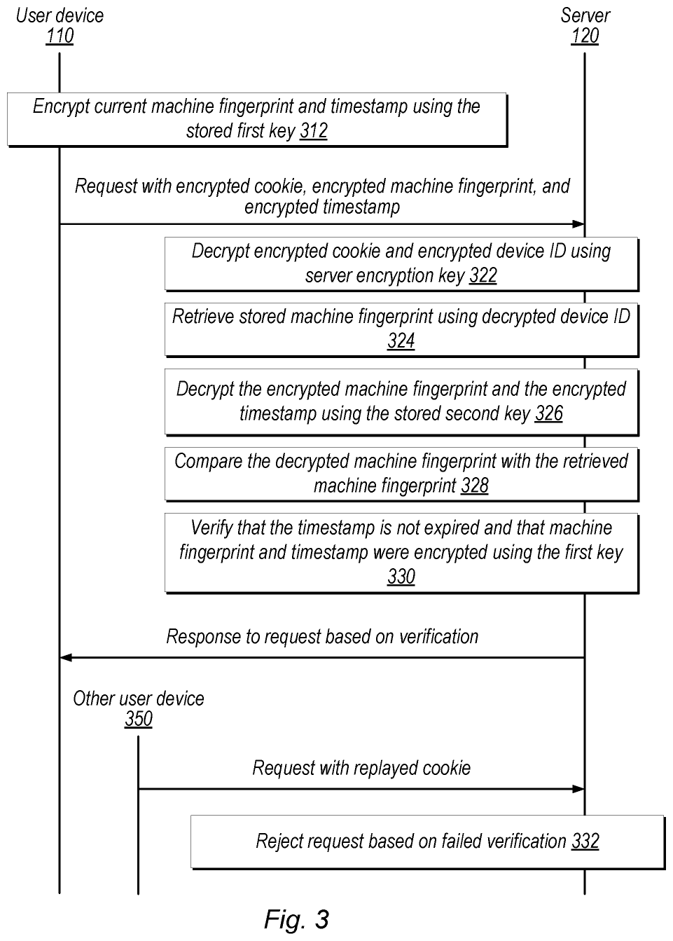

In some embodiments, server system 120 decrypts the received encrypted cookie data using server encryption key 126. Server system 120 may also retrieve previously-stored device identification information 124 based on the decrypted cookie. In addition, server system 120 decrypts the device identification information, received from user device 110, using second key 122. Server system 120 compares the decrypted device identification information with the previously-stored device identification information 124. In some embodiments, based on the comparison, server system 120 determines whether to use the cookie data received from user device 110 for the request. In some embodiments, server system 120 performs one or more verification steps (discussed in detail below with reference to FIG. 3), in addition to the comparison, before determining whether to use the cookie data received from user device 110. Note that the disclosed verification techniques may be used within a user session or across multiple user sessions.

As used herein, the term “cookie data” is intended to be construed according to its well-understood meaning which includes messages transmitted from a server to a client device or from the client device to the server to track user activity or preferences. Examples of information that may be indicated in a cookie include, without limitation: content viewed by a user (e.g., via a web browser), user login credentials, length of user session, selected items, user identification, etc. A cookie received from the server may be stored on the device to be sent to the server for future (subsequent) requests. In this way, user data may be populated or the device may be authenticated for the subsequent request without requiring input from a user of the device.

### Example Initial Communications for a Cookie

FIG. 2 is a communication diagram illustrating an example initial cookie exchange, according to some embodiments. In the illustrate embodiment, user device 110 sends a request with a machine fingerprint to server 120 based on user input (e.g., a request to visit a website, access an account, etc.). In some embodiments, the user input includes credentials (e.g., a username and password) for a user account. In some embodiments, the user input indicates user activity.

A user device (e.g., user device 110) may generate a machine fingerprint based on one or more of the following characteristics of the user device: hardware identifiers (e.g., model numbers or serial numbers), hardware attributes (e.g., measured microphone characteristics, screen resolution, or measured camera characteristics), determined location, installed programs, active programs, program versions, etc.

At 222, in the illustrated embodiment, server 120 generates a cookie and a key pair that includes a first key and a second key. In some embodiments, the first and second keys are public and private keys, respectively.

At 224, in the illustrated embodiment, server 120 generates a unique device identifier (ID) and associates it with the machine fingerprint received from the user device 110 (which may facilitate future retrieval of the machine fingerprint). At 226, server 120 stores the machine fingerprint and the second key. At 228, server 120 encrypts the cookie and the unique device ID using the server encryption key. In some embodiments, server 120 embeds the unique device ID in the cookie before encrypting the cookie. In other embodiments, the unique device ID is appended to the cookie before encrypting the cookie. Various different combinations of the cookie and unique device ID may be encrypted and sent to user device 110.

Server 120, in the illustrated embodiment, sends the first key, the encrypted cookie, and the encrypted unique device ID to user device 110. At 212, user device 110 stores the encrypted cookie, the encrypted unique device ID, and the first key received from server 120 for future requests.

Note that the device ID may be “unique” in the sense that it is not used by server 120 for any other devices while it is assigned to user device 110. Once the device ID is no longer being used for user device 110, however, the device ID may be assigned to another device. The device ID may be encoded using various combinations of characters that include letters, numbers, symbols, etc.

### Example Communication for Subsequent Requests

FIG. 3 is a communication diagram illustrating example communication between a user device and a server for a subsequent request involving a cookie, according to some embodiments. In the illustrated embodiment, user device 110 communicates with server 120 for a request that is subsequent to the communications of FIG. 2.

At 312, in the illustrated embodiment, user device 110 encrypts a current machine fingerprint and a timestamp using the stored first key (e.g., the key stored at block 212 of FIG. 2). Note that the current machine fingerprint may vary relative to the version stored by the server. For example, the version of software downloaded on user device 110 for the subsequent request may be different from the software version downloaded on the same device during the initial request (e.g., the request from user device 110 in FIG. 2). In some embodiments, fingerprints are matched to within an acceptable variation threshold.

User device 110, in the illustrated embodiment, sends a request to server 120, where the request includes the encrypted cookie, the encrypted machine fingerprint, and the encrypted timestamp. At 322, server 120 decrypts the encrypted cookie and the encrypted unique device ID using a server encryption key. At 324, server 120 retrieves the previously-stored machine fingerprint using the decrypted unique device ID.

At 326, server 120 decrypts the encrypted machine fingerprint and the encrypted timestamp received from user device 110 using the stored second key. At 328, server 120 compares the decrypted current machine fingerprint with the retrieved fingerprint (e.g., the fingerprint from the previous request that was stored on the server). The comparison may not require an exact match, but may require a match to within one or more comparison thresholds. For example, if the two compared versions are at least 80% similar, a match may be indicated. After comparing the two versions of the machine fingerprint, server 120, at element 330, verifies that the timestamp has not expired, and that the machine fingerprint and the timestamp were encrypted using the second key. In some embodiments, based on this verification, server 120 determines whether the cookie received from user device 110 for the subsequent request is valid. In some embodiments, server 120 compares the machine fingerprint versions only if the decryption is successful. For example, elements 328 and 330 may be combined or one may be performed but not the other.

Server 120 responds to the request from the user device 110 based on the verification. In some embodiments, server 120 does not perform element 330, but responds to the request based on the comparison performed at element 328. Based on receiving a response from server 120, user device 110 may display information to the user.

In the illustrated example, another user device 350 attempts to replay the cookie and sends a request to server 120. Based on receiving the request, server 120 performs a verification sequence on the cookie. Server 120 rejects the request based on a failed verification. In some embodiments, the request from device 350 fails based on one or more of the following: there is no unique device ID included with the cookie, there is no machine fingerprint sent with the cookie, a received machine fingerprint does not match the stored and retrieved machine fingerprint, a timestamp sent with the cookie has expired, a timestamp or machine fingerprint were not encrypted using the proper key, etc. In some embodiments, server 120 may send a notification that the request has failed to device 350.

In various embodiments, the disclosed techniques may advantageously increase security of cookie data and reduce or avoid man-in-the-middle attacks.

### Example Method

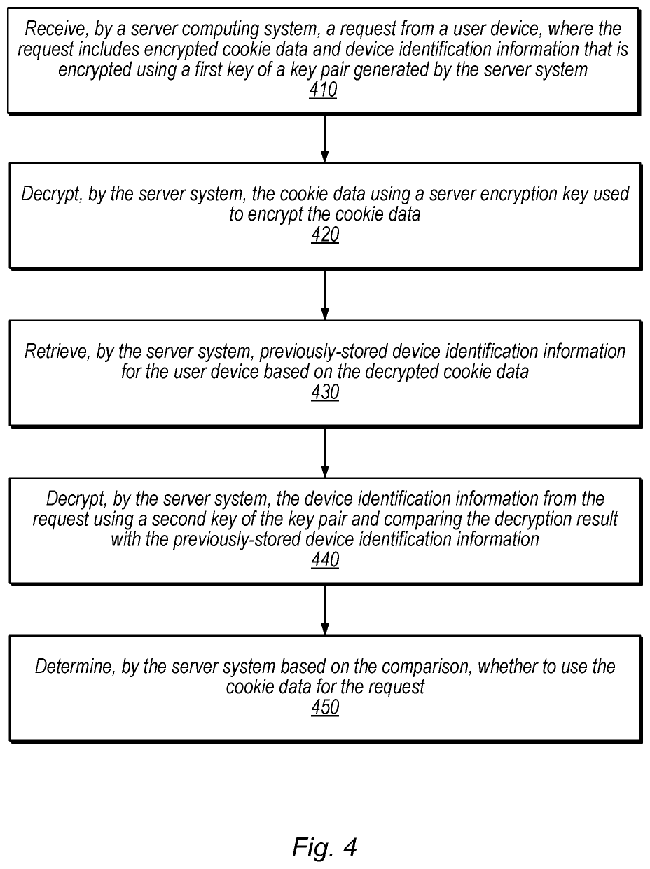

FIG. 4 is a block diagram illustrating an example method for determining whether to use encrypted cookie data for a request, according to some embodiments. The method shown in FIG. 4 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 410, in the illustrated embodiment, a server computing system receives a request from a user device, where the request includes encrypted cookie data and device identification information that is encrypted using a first key of a key pair generated by the server system. In some embodiments, the device identification information for the user device is a machine fingerprint that includes information specifying one or more characteristics of hardware included in the device and one or more characteristics of software installed on the device.

At 420 the server system decrypts the cookie data using a server encryption key used to encrypt the cookie data.

At 430 the server system retrieves previously-stored device identification information for the user device based on the decrypted cookie data.

At 440 the server system decrypts the device identification information from the request using a second key of the key pair and compares the decryption result with the previously-stored device identification information. In some embodiments, the server system verifies that the device identification information received for the request was encrypted using the first key based on a format of the decrypted device identification information. In some embodiments, the first key of the key pair is a public key and the second key is a private key.

At 450 the server system determines, based on the comparison, whether to use the cookie data for the request. In some embodiments, the server system determines whether to use the cookie data based on decrypting a timestamp and verifies that the timestamp was encrypted using the first key of the key pair based on a format of the decrypted timestamp. For example, if the format of the decrypted timestamp is not an expected format (e.g., does not indicate encryption by the first key), the server system may determine not to use the cookie data for the request.

In some embodiments, in response to receiving a previous request from the user device that includes device identification information, the server computing system generates cookie data for the user device. In some embodiments, the server system generates the key pair for the user device, where the key pair includes the first key and second key. In some embodiments, the server system receives device identification information from the user device and associates the received information with the cookie data. In some embodiments, the server system stores the device identification information and the second key. In some embodiments, the server system encrypts the cookie data using a server encryption key. In some embodiments, the server system transmits the encrypted cookie data and the first key to the user device.

In some embodiments, the server system generates a unique device identifier and associates it with the device identification information. In some embodiments, the server system encrypts the unique device identifier using the server encryption key and transmits the encrypted unique device identifier to the user device. In some embodiments, the server system receives the encrypted unique device identifier for the request from the user device. In some embodiments the server system decrypts the unique device identifier and retrieves the previously-stored device identification information based on the decrypted unique device identifier. In some embodiments, the server system generates a similarity value based on comparing the decryption result with the previously-stored device identification information. In some embodiments, the server system determines whether to use the cookie for the request based on the similarity value meeting a threshold value.

In some embodiments, an apparatus is configured to retrieve a stored first key of a key pair generated by a server computing system. In some embodiments, the apparatus is configured to generate current device identification information and encrypt the device identification information using the retrieved first key and send, to the server computing system, a request that includes cookie data encrypted using a server encryption key and the encrypted device identification information. In some embodiments, the apparatus is configured to receive, from the server system, a response to the request based on the server system performing a verification process on the encrypted cookie data and encrypted device identification information. In some embodiments, the verification process includes: decrypting the encrypted cookie data using the server encryption key, retrieving previously-stored device identification information based on the decrypted cookie data, decrypting the current device identification information sent with the request using a second key of the key pair and comparing the decryption result with the previously-stored device identification information, and determining, based on the comparing, whether to use the cookie data for the request.

In some embodiments, the apparatus is configured to encrypt a timestamp and transmit, to the server system, the encrypted timestamp in conjunction with the encrypted cookie data. In some embodiments the apparatus is configured to send, to the server system prior to sending the request that includes cookie data, a previous request that includes device identification information. In some embodiments, the apparatus is configured to receive the first key of the key pair and the cookie data encrypted using the server encryption key and store the encrypted cookie data and the first key.

In some embodiments, the apparatus is configured to receive, from the server system, an encrypted unique device identifier. In some embodiments, the apparatus is configured to send to the server system, in conjunction with the request, the encrypted unique device identifier. In some embodiments, the device identification information is a machine fingerprint that includes information specifying: one or more characteristics of hardware included in the device and one or more characteristics of software installed on the device. Note that, in some embodiments, a non-transitory computer-readable medium having instructions thereon that are executable by one or more processors to perform the operations discussed above.

The disclosed techniques for encrypting cookie data may advantageously reduce or prevent situations where malicious users access private user information (e.g., through cookie replay attacks). In some embodiments, implementing cookie encryption in combination with using a key pair to encrypt device identification information (e.g., a machine fingerprint) and verifying the encryption of both device identification information and cookie data before using cookie data for a user session may further improve user security. In some embodiments, including encrypted timestamp information and an encrypted unique device identifier in a verification process performed by a server computing system may further increase security.

### Example Computing Device

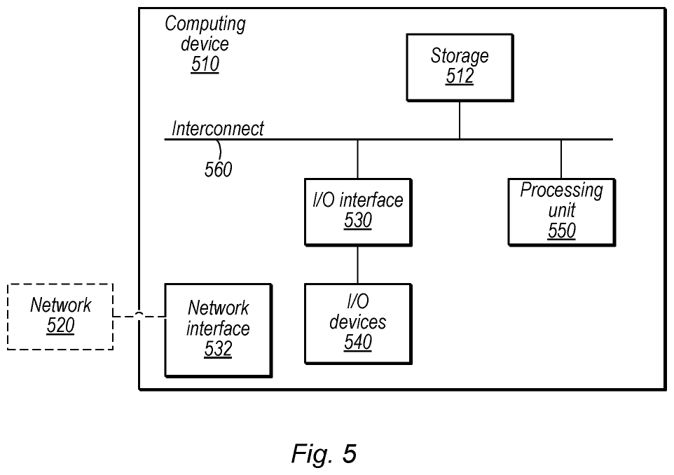

Turning now to FIG. 5, a block diagram of a computing device (which may also be referred to as a computing system) 510 is depicted, according to some embodiments. Computing device 510 may be used to implement various portions of this disclosure. Computing device 510 is one example of a device that may be used as a mobile device, a server computer system, a client computer system, or any other computing system implementing portions of this disclosure.

Computing device 510 may be any suitable type of device, including, but not limited to, a personal computer system, desktop computer, laptop or notebook computer, mobile phone, mainframe computer system, web server, workstation, or network computer. As shown, computing device 510 includes processing unit 550, storage subsystem 512, and input/output (I/O) interface 530 coupled via interconnect 560 (e.g., a system bus). I/O interface 530 may be coupled to one or more I/O devices 540. Computing device 510 further includes network interface 532, which may be coupled to network 520 for communications with, for example, other computing devices.

Processing unit 550 includes one or more processors, and in some embodiments, includes one or more coprocessor units. In some embodiments, multiple instances of processing unit 550 may be coupled to interconnect 560. Processing unit 550 (or each processor within processing unit 550) may contain a cache or other form of on-board memory. In some embodiments, processing unit 550 may be implemented as a general-purpose processing unit, and in other embodiments it may be implemented as a special purpose processing unit (e.g., an ASIC). In general, computing device 510 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 512 is usable by processing unit 550 (e.g., to store instructions executable by and data used by processing unit 550). Storage subsystem 512 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 512 may consist solely of volatile memory in some embodiments. Storage subsystem 512 may store program instructions executable by computing device 510 using processing unit 550, including program instructions executable to cause computing device 510 to implement the various techniques disclosed herein.

I/O interface 530 may represent one or more interfaces and may be any of various types of interfaces configured to couple to and communicate with other devices, according to various embodiments. In some embodiments, I/O interface 530 is a bridge chip from a front-side to one or more back-side buses. I/O interface 530 may be coupled to one or more I/O devices 540 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that the computing device of FIG. 5 is one embodiment for demonstrating disclosed concepts. In other embodiments, various aspects of the computing device may be different. For example, in some embodiments, additional components, or multiple instances of the illustrated components may be included.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a server computing system, a request from a user device, wherein the request includes encrypted cookie data and device identification information that is encrypted using a first key of a key pair generated by the server system;
decrypting, by the server system, the cookie data using a server encryption key used to encrypt the cookie data;
retrieving, by the server system, previously-stored device identification information for the user device based on the decrypted cookie data;
decrypting, by the server system, the device identification information from the request using a second key of the key pair and comparing the decryption result with the previously-stored device identification information; and
determining, by the server system based on the comparison, whether to use the cookie data for the request.

2. The method of claim 1, further comprising:
in response to receiving a previous request that includes device identification information from the user device, the server computing system generating cookie data for the user device;
generating, by the server system, the key pair for the device, wherein the key pair includes the first key and the second key;
receiving device identification information from the user device and associating the received information with the cookie data;
storing the device identification information and the second key;
encrypting the cookie data using a server encryption key; and
transmitting the encrypted cookie data and the first key to the user device.

3. The method of claim 1, wherein the determining whether to use the cookie data is based on:
decrypting a timestamp and verifying that the timestamp was encrypted using the first key of the key pair based on a format of the decrypted timestamp.

4. The method of claim 1, further comprising:
verifying that the device identification information received for the request was encrypted using the first key based on a format of the decrypted device identification information.

5. The method of claim 1, further comprising:
generating, by the server system, a unique device identifier and associating it with the device identification information;
encrypting the unique device identifier using the server encryption key;
transmitting, to the user device from the server system, the encrypted unique device identifier;
receiving, by the server system from the user device, the encrypted unique device identifier with the request from the user device; and
decrypting, by the server system, the unique device identifier and retrieving the previously-stored device identification information based on the decrypted unique device identifier.

6. The method of claim 1, wherein the comparing the decryption result with the previously-stored device identification information further includes:
generating a similarity value, wherein the determining whether to use the cookie for the request is based on the similarity value meeting a threshold value.

7. The method of claim 1, wherein the first key of the key pair is a public key and the second key is a private key.

8. The method of claim 1, wherein the device identification information for the user device is a machine fingerprint that includes information specifying:
one or more characteristics of hardware included in the device; and
one or more characteristics of software installed on the device.

9. A non-transitory computer-readable medium having instructions stored thereon that are executable by a user device to perform operations comprising:
retrieving a stored first key of a key pair generated by a server computing system;
generating current device identification information and encrypting the current device identification information using the retrieved first key;
sending, to the server computing system, a request that includes cookie data encrypted using a server encryption key and the encrypted current device identification information; and
receiving, from the server system, a response to the request based on the server system performing a verification process on the encrypted cookie data and the encrypted current device identification information.

10. The non-transitory computer-readable medium of claim 9, wherein the verification process includes the server system:
decrypting the encrypted cookie data using the server encryption key;
retrieving previously-stored device identification information based on the decrypted cookie data;
decrypting the current device identification information sent with the request using a second key of the key pair and comparing the decryption result with the previously-stored device identification information; and
determining, based on the comparing, whether to use the cookie data for the request.

11. The non-transitory computer-readable medium of claim 10, further comprising:
encrypting a timestamp and transmitting, to the server system, the encrypted timestamp in conjunction with the encrypted cookie data.

12. The non-transitory computer-readable medium of claim 10, wherein the first key is a public key of a public-private key pair.

13. The non-transitory computer-readable medium of claim 9, wherein the operations further comprise:
prior to sending the request that includes cookie data, sending, by the user device to the server system, a previous request that includes device identification information generated by the user device;
receiving, by the user device from the server system, the first key of the key pair and the cookie data encrypted using the server encryption key; and
storing, by the user device, the encrypted cookie data and the first key.

14. The non-transitory computer-readable medium of claim 9, wherein the operations further comprise:
receiving, by the user device from the server system, an encrypted unique device identifier; and
sending to the server system, in conjunction with the request, the encrypted unique device identifier.

15. The non-transitory computer-readable medium of claim 9, wherein the device identification information for the user device is a machine fingerprint that includes information specifying:
one or more characteristics of hardware included in the device; and
one or more characteristics of software installed on the device.

16. An apparatus, comprising:
one or more processors configured to:
retrieve a stored first key of a key pair generated by a server computing system;
generate current device identification information and encrypting the device identification information using the retrieved first key;
send, to the server computing system, a request that includes cookie data encrypted using a server encryption key and the encrypted device identification information; and
receive, from the server system, a response to the request based on the server system performing a verification process on the encrypted cookie data and encrypted device identification information.

17. The apparatus of claim 16, wherein the apparatus is further configured to:
encrypt a timestamp and transmit, to the server system, the encrypted timestamp in conjunction with the encrypted cookie data.

18. The apparatus of claim 16, wherein the apparatus is further configured to:
send, to the server system prior to sending the request that includes cookie data, a previous request that includes device identification information;
receive the first key of the key pair and the cookie data encrypted using the server encryption key; and
store the encrypted cookie data and the first key.

19. The apparatus of claim 16, wherein the apparatus is further configured to:
receive, from the server system, an encrypted unique device identifier; and
send to the server system, in conjunction with the request, the encrypted unique device identifier.

20. The apparatus of claim 16, wherein the device identification information is a machine fingerprint that includes information specifying:
one or more characteristics of hardware included in the device; and
one or more characteristics of software installed on the device.
